(19) United States
(12) Patent Application Publication
(10) Pub. No.: US 2011/0286038 A1
(43) Pub. Date: Nov. 24, 2011

(54) IMAGE READING APPARATUS, IMAGE PRINTING APPARATUS, HELP DISPLAY CONTROLLER, HELP DISPLAY CONTROL METHOD, AND COMPUTER READABLE MEDIUM FOR DISPLAYING HELP

(75) Inventors: Tomonori YUASA, Ishikawa (JP); Yoshiyuki MURAKAMI, Ishikawa (JP); Yoshiki NAKAMURA, Ishikawa (JP)

(73) Assignee: PFU LIMITED, Ishikawa (JP)

(21) Appl. No.: 13/095,080

(22) Filed: Apr. 27, 2011

(30) Foreign Application Priority Data
May 24, 2010 (JP) 2010-118808

(51) Int. Cl. G06F 3/12; G06F 3/00

(52) U.S. Cl. 358/1.15; 715/705

(57) ABSTRACT

There is provided an image reading apparatus including an image reading unit that reads image data optically from an information display medium, an operation screen display unit that displays an operation screen to receive input from a user with respect to an image reading process performed by the image reading unit, and a help screen display unit that displays, in accordance with a displayed operation screen displayed by the operation screen display unit, help guidance relating to the displayed operation screen in a manner that the help guidance and the displayed operation screen are visible at the same time.

### CROSS-REFERENCE TO RELATED APPLICATIONS

This application is based on and claims priority under 35 USC 119 from Japanese Patent Application No. 2010-118808 filed May 24, 2010.

### BACKGROUND OF THE INVENTION

### Field of the Invention

The present invention relates to a help display controller.

### SUMMARY OF THE INVENTION

According to an aspect of the invention, there is provided an image reading apparatus including an image reading unit that reads image data optically from an information display medium, an operation screen display unit that displays an operation screen to receive input from a user with respect to an image reading process performed by the image reading unit, and a help screen display unit that displays, in accordance with a displayed operation screen displayed by the operation screen display unit, help guidance relating to the displayed operation screen in a manner that the help guidance and the displayed operation screen are visible at the same time.

### BRIEF DESCRIPTION OF THE DRAWINGS

Exemplary embodiments of the present invention will be described in detail based on the following figures, wherein:

FIG. 1 is a schematic diagram illustrating an image reading apparatus 1;

FIG. 2 is a diagram exemplifying a functional configuration of a help display control program 100;

FIG. 3 is a diagram exemplifying a help map data base 110;

FIG. 4 is a diagram exemplifying a help information data base 112;

FIG. 5 is a flowchart depicting a help display control process S10;

FIG. 6 is a descriptive view depicting changes of screens displayed by the image reading apparatus 1;

FIG. 7 is a diagram exemplifying functional configurations of a help display control program 200 and a remote terminal program 300 in Modified Embodiment 2;

FIG. 8 is a descriptive view depicting changes of screens displayed by the image reading apparatus 1 in Modified Embodiment 3;

FIG. 9 is a diagram exemplifying a functional configuration of a help display control program 500 in Modified Embodiment 4;

FIG. 10 is a diagram exemplifying a count data base 518; and

FIG. 11 is a descriptive view depicting changes of screens displayed by the image reading apparatus 1 in Modified Embodiment 4.

### DETAILED DESCRIPTION OF THE INVENTION

Hereafter, exemplary embodiments according to the invention will be described with reference to the accompanying drawings.

### Exemplary Embodiment 1

FIG. 1 is a schematic diagram illustrating an image reading apparatus 1.

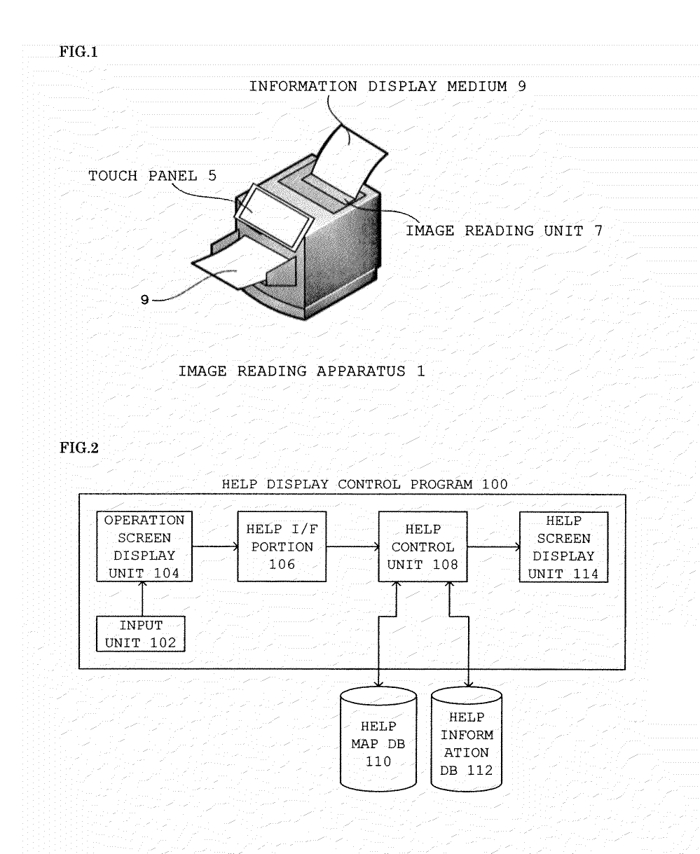

As exemplified in FIG. 1, the image reading apparatus 1 includes a touch panel 5 and an image reading unit 7. A help display control program 100 is installed on the image reading apparatus 1 as described later with reference to FIG. 2.

The touch panel 5 mainly displays an operation screen and a help screen by the function implemented by the help display control program 100. Further, the touch panel 5 is used to operate the image reading apparatus 1 through touch operation by a user.

The image reading unit 7 mechanically feeds an information display medium 9 by rollers into the apparatus upon touching operation by a user through the touch panel 5 and optically reads image data representing the information display medium 9. Here, the image reading unit 7 is not limited to a feeding type as illustrated but may be a flatbed type in which the information display medium 9 is stationary placed on a glass platen and optically scanned for reading. The information display medium 9 is a thin sheet-like medium indicating information thereon and may be in a form of paper or film depicting information.

FIG. 2 is a diagram exemplifying a functional configuration of a help display control program 100.

As exemplified in FIG. 2, the help display control program 100 functionally includes an input unit 102, an operation screen display unit 104, a help I/F (interface) unit 106, a help control unit 108, and a help screen display unit 114. The help display control program 100 functions to read and write a help map database (help map DB) 110 and a help information data base (help information DB) 112.

A part or whole of the functional units of the help display control program 100 may be realized by hardware such as an ASIC.

Hereinafter, a description will be given of the illustrated individual units.

The input unit 102 receives input from a user by means of various input devices such as a keyboard, a mouse, or a touch panel.

The operation screen display unit 104 displays an operation screen for receiving the input from the user.

In this example, the operation screen display unit 104 changes the operation screens to be displayed from one to another according to the input by the user which is received by the input unit 102. Then, the operation screen display unit 104 notifies the help I/F unit 106 of the change of operation screens. Here, the change of screens (such as the change of operation screens) means that the screens are switched from one to another, and includes, for example, switching pages by scrolling operation, jumping to the link destination according to click operation, and the like.

The help I/F unit 106 notifies the help control unit 108 of help identification information (hereinafter, “help ID”) that is associated with an operation screen displayed by the operation screen display unit 104.

In this example, the help I/F unit 106 receives a notification indicating a change of operation screens from the operation display unit 104 and notifies the help control unit 108 of a help ID that is associated with the changed operation screen.

The help control unit 108 obtains help information based on the help ID that is notified from the help I/F unit 106.

In this example, the help control unit 108, first, obtains help acquisition information for obtaining help information from the help map DB 110 based on the help ID notified from the help I/F unit 106. The help control unit 108, then, obtains the help information from the help information DB 112 based on the help acquisition information that has been obtained from the help map DB 110. Here, the help information DB 112 may be stored in an external storage or the like connected via a communication network.

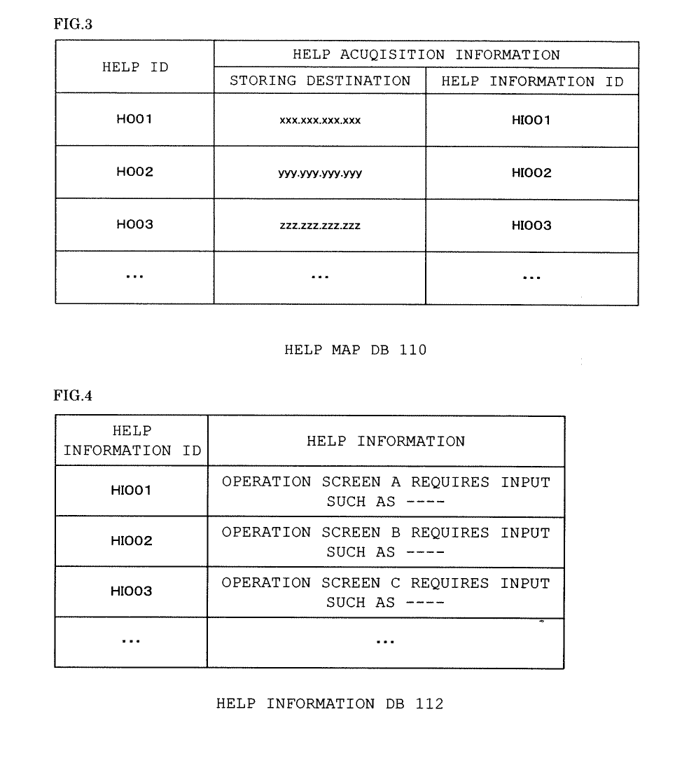

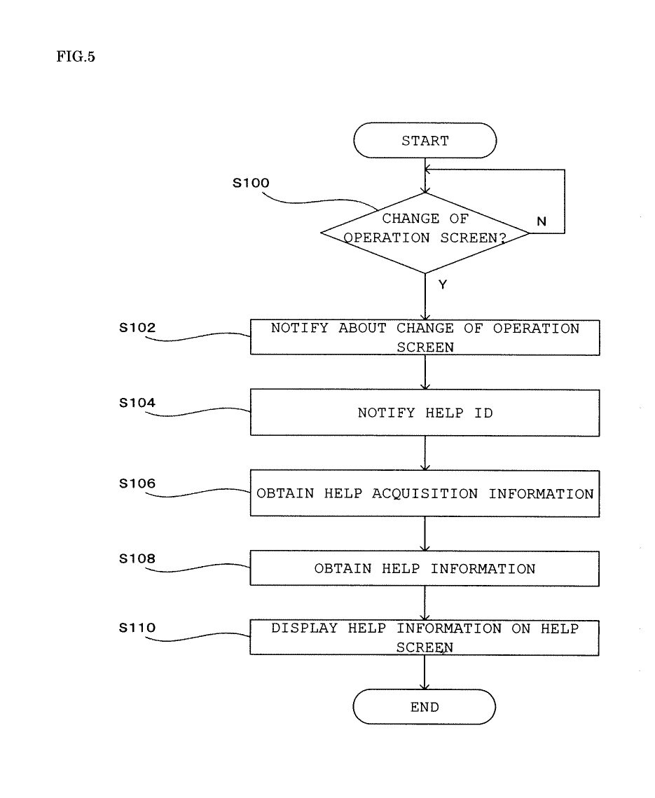

As exemplified in FIG. 3, the help map DB 110 includes “Help ID” and “Help Acquisition Information” as data items.

The help ID is identification information for uniquely identifying a help screen that is associated with an operation screen and, for example, is expressed by a combination of text, numerals, symbols, and the like.

The help acquisition information is the information for obtaining the help information from the help information DB 112.

In this example, the help acquisition information consists of a storing destination of the help information DB 112 (such as an IP address and a storage path), and a help information ID for uniquely identifying the help information.

As exemplified in FIG. 4, the help information DB 112 includes, as data items, “Help Information ID” and “Help Information”. The help information ID is identification information for uniquely identifying help information and, for example, is expressed by a combination of text, numerals, symbols, and the like.

The help information is in the form of text, an image, or sound for explaining how to use the operation screen.

The help screen display unit 114 displays help guidance about an operation screen in accordance with the operation screen display by the operation screen display unit 104.

In this example, the help screen display unit 114 displays the help information obtained by the help control unit 108 on a help screen which is different from the operation screen displayed by the operation screen display unit 104.

By installing the help display control program 100 described above on a computer, the computer includes the functions implemented by the help display control program 100 and operates as a help display controller or the image reading apparatus 1.

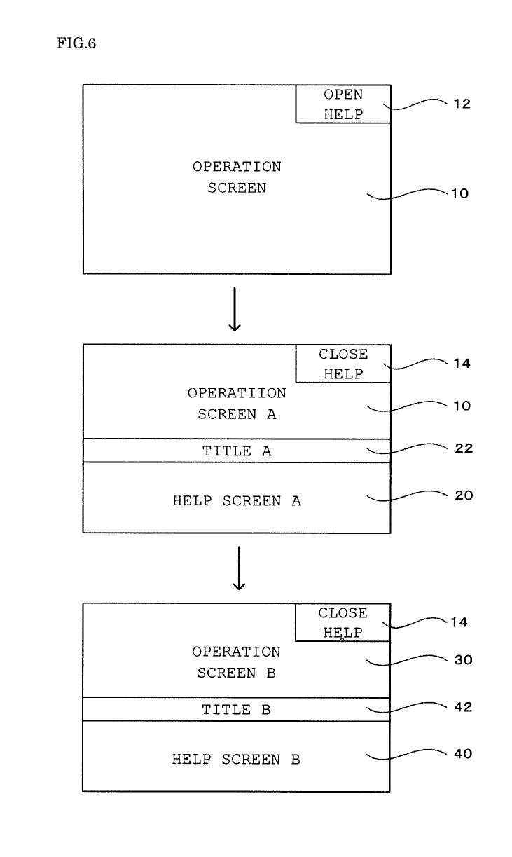

FIG. 5 is a flowchart depicting a help display control process S10.

As exemplified in FIG. 5, the operation screen display unit 104 determines in step S100 whether or not there is a change of operation screens based on the input received by the input unit 102. If there is a change of operation screens, the flow of the help display control program 100 moves to step S102. If there is no change of operation screens, the flow repeats step S100.

In step S102, the operation screen display unit 104 notifies the help I/F unit 106 of the change of operation screens.

In step S104, upon receiving the notification of the change of operation screens from the operation screen display unit 104, the help I/F unit 106 notifies the help control unit 108 of the help ID that is associated with the changed operation screen.

In step S106, the help control unit 108 obtains help acquisition information for obtaining help information from the help map DB 110 based on the help ID notified from the help I/F unit 106.

In step S108, the help control unit 108 obtains help information from the help information DB 112 based on the help acquisition information obtained from the help map DB 110.

In step S110, the help screen display unit 114 displays the help information obtained by the help control unit 108 on a help screen which is different from the operation screen displayed by the operation screen display unit 104.

FIG. 6 is a descriptive view depicting changes of screens displayed by the image reading apparatus 1.

As exemplified in FIG. 6, the image reading apparatus 1, first, displays an operation screen A 10 for receiving the input from a user. An “open help” button 12 for displaying the help screen is arranged on the operation screen A 10.

Next, when the “open help” button 12 is depressed by the user, the image reading apparatus 1 divides the whole screen vertically into two, and displays the operation screen A 10 in an upper part of the whole screen and a help screen A 20 in a lower part of the whole screen with a title A 22 of help interposed therebetween. A “close help” button 14 is displayed on the operation screen A 10 in place of the “open help” button 12. When the “close help” button 14 is depressed, the image reading apparatus 1 closes the help screen A 20 and brings back the screen to a state where only the operation screen A 10 is displayed. Here, the help screen A 20 displays text or images (hereinafter, “help”) for explaining how to use the operation screen A 10 which is displayed in the upper part of the whole screen. In addition, the title A 22 reflects the contents of the help that is displayed in the help screen A 20 and changes in accordance with the contents of the help displayed on the help screen A 20.

Next, when the operation screen A 10 is switched to an operation screen B 30 in response to the input or the like received from a user on the operation screen A 10, the image reading apparatus 1 switches the help screen A 20 to a help screen B 40 that displays the help for explaining how to use the operation screen B 30. Also, a title B 42 is changed to such a title that reflects the contents of the help displayed on the help screen B 40.

In this way, the image reading apparatus 1 displays a help screen that indicates the help for explaining how to use the operation screen currently displayed in a form that can be visible by a user concurrently with the operation screen in accordance with a change of operation screens.

However, the screens are not limited to such screens that are illustrated in the drawing. Alternatively, for example, the screen can be divided along a vertical line into right and left or can use a part of the screen for displaying the help screen.

According to the configuration and operation described above, the image reading apparatus 1 can automatically display the help in a form according to the operation screen that is changed in response to the input by the user. When displaying the help, the image reading apparatus 1 displays the help in such a way that a user can view the help concurrently with the operation screen. Accordingly, the input on the operation screen by the user is not disturbed. To be specific, the user does not need to switch the screen over to the help screen each time the user checks the operation as conventionally performed and can effectively perform the input operation on the operation screen while referring to the help.

### Modified Embodiment 1

According to the foregoing embodiment, one screen is divided into a plurality of screens, and the help is displayed on a part of the divided screens. However, the embodiment is not limited to such an example. For example, it is also possible to display a plurality of windows that can overlap one another on one screen, and display the help on one of the windows or display the help on one of a plurality of screens that can be physically separated from each other.

### Modified Embodiment 2

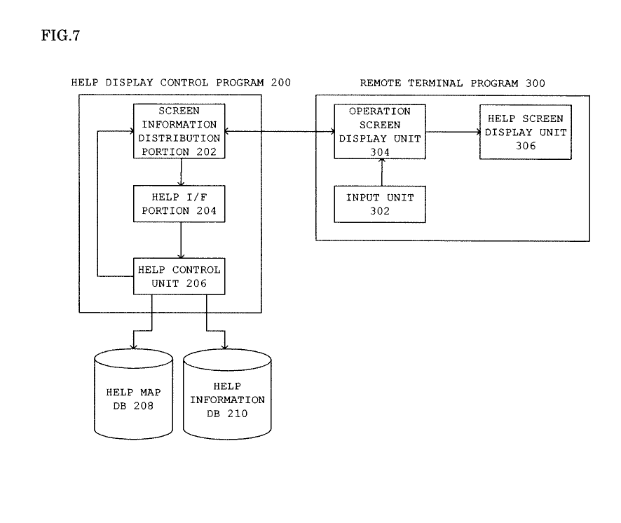

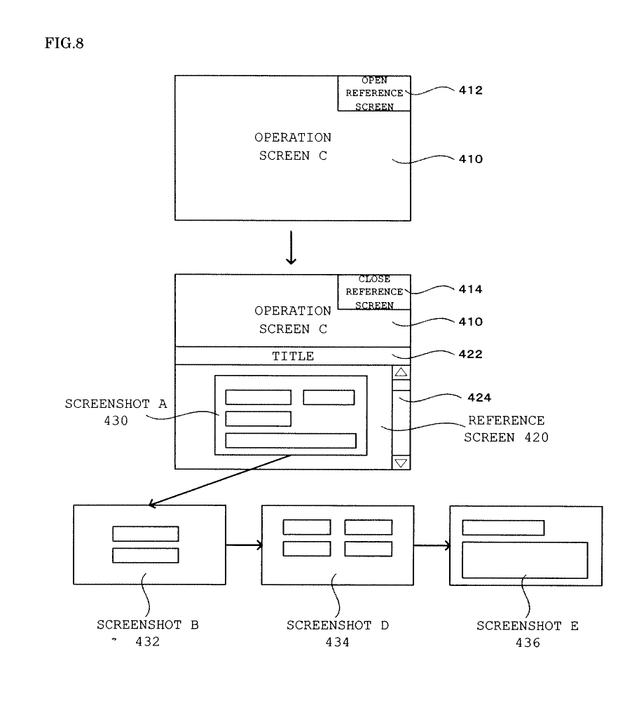

FIG. 7 is a diagram exemplifying functional configurations of a help display control program 200 and a remote terminal program 300 in Modified Embodiment 2.

As exemplified in FIG. 7, the help display control program 200 functionally includes a screen information distribution unit 202, a help I/F unit 204, and a help control unit 206. The help display control program 200 also functions to read and write a help map database (help map DB) 208 and a help information data base (help information DB) 210.

The remote terminal program 300 functionally includes an input unit 302, an operation screen display unit 304, and a help screen display unit 306.

A part or whole of the functional units of the help display control program 200 and the remote terminal program 300 may be realized by hardware such as an ASIC.

Hereinafter, a description will be given of the illustrated individual units.

In the help display control program 200, the screen information distribution unit 202 distributes information of the operation screen and the help screen via the communication network in response to a request from the operation screen display unit 304 of the remote terminal program 300.

In this example, the screen information distribution unit 202, in response to the request from the operation screen display unit 304, notifies the help I/F unit 204 that the operation screen to be distributed has been changed. In addition, the screen information distribution unit 202, along with the distribution of the operation screen that has been requested, distributes the help information obtained by the help control unit 206 as the information of the help screen.

The help I/F unit 204 notifies the help control unit 206 of the help ID that is associated with the operation screen to be distributed by the screen information distribution unit 202.

In this example, upon receiving the notification that the operation screen has been changed from the screen information distribution unit 202, the help I/F unit 204 notifies the help control unit 206 of the help ID associated with the changed operation screen.

The help control unit 206 obtains the help information based on the help ID notified from the help I/F unit 204.

In this embodiment, first, the help control unit 206, based on the help ID notified from the help I/F unit 204, obtains the help acquisition information for obtaining the help information from the help map DB 208. Then, the help control unit 206 obtains the help information from the help information DB 210 based on the help acquisition information obtained from the help map DB 208. Here, the help map DB 208 and the help information DB 210 are the same as the help map DB 110 and the help information DB 112 illustrated in FIG. 2, respectively.

In the remote terminal program 300, the input unit 302 receives input from a user by means of various input devices such as a keyboard, a mouse, or a touch panel.

The operation screen display unit 304 displays an operation screen for receiving the input from the user which is distributed from the screen information distribution unit 202 of the help display control program 200.

In this example, the operation screen display unit 304, according to the input by the user received by the input unit 302, requests the screen information distribution unit 202 to distribute the operation screen and displays the operation screen that is distributed from the screen information distribution unit 202. In addition, the operation screen display unit 304 passes the help information that is distributed along with the distribution of the operation screen to the help screen display unit 306.

The help screen display unit 306 displays the help information received from the operation screen display unit 304 on a help screen that is different from the operation screen displayed by the operation screen display unit 304.

By installing the help display control program 200 and the remote terminal program 300 described above individually on a computer, the computer acquires the functions implemented by the help display control program 200 and the remote terminal program 300, and operates as the help display controller or the image reading apparatus 1, and the remote terminal.

With this configuration, the remote terminal can display the operation screen that is distributed from the help display controller or the image reading apparatus 1 via the communication network and also display, at the same time, the help that explains how to use the operation screen. In addition, the remote terminal, in accordance with the change of the operation screens distributed from the help display controller or the image reading apparatus 1, can automatically switch over to and display the help corresponding to the changed operation screen.

### Modified Embodiment 3

FIG. 8 is a descriptive view depicting changes of screens displayed by the image reading apparatus 1 in Modified Embodiment 3.

As exemplified in FIG. 8, first, the image reading apparatus 1 displays an operation screen C 410 for receiving input by a user. An “open reference screen” button for opening a reference screen is arranged on the operation screen C 410. The operation screen C is one of a plurality of operation screens that change from one to another. These plurality of operation screens (reference screens) are a series of operation screens that are associated with one another and a group of screens that are sequentially displayed in accordance with the switching operation by the user.

Next, when the “open reference screen” button 412 is depressed by a user, the image reading apparatus 1 divides the whole screen vertically into two, and displays the operation screen C 410 in an upper part of the whole screen and a reference screen C 420 in a lower part of the whole screen with a title 422 of the reference screen interposed therebetween. A “close reference screen” button 414 is displayed on the operation screen C 410 in place of the “open reference screen” button 412. When the “close reference screen” button 414 is depressed, the image reading apparatus 1 closes the reference screen 420 and brings back the screen to a state where only the operation screen C 410 is displayed. Here, the reference screen 420 represents screenshots A 430, B 432, D 434, and E 436 of the operation screens other than the operation screen C 410 that is displayed in the upper part of the whole screen. Here, the screenshots A 430, B 432, D 434, and E 436 are displayed all by operating a scroll bar 424 on the reference screen 420.

Next, when the operation screen C 410 is changed to a different operation screen in response to the input or the like received from the user on the operation screen C 410, the image reading apparatus 1 displays a reference screen representing screenshots of operation screens other than the different operation screen that has been changed to.

To perform such a change of screens, the help control unit 108 obtains, instead of help information, reference information for displaying an operation screen other than the operation screen that is currently displayed based on the help ID notified from the help I/F unit 106. Then, the help screen display unit 114 displays the reference information obtained by the help control unit 108 on a reference screen other than the operation screen that is displayed by the operation screen display unit 104.

According to the configuration and operation described above, the image reading apparatus 1 can automatically display the reference screen according to the operation screen that is changed in response to the input by the user. Then, the user can perform input operation on the current operation screen while checking, on the reference screen, the information etc. entered in the past. Accordingly, during input operation performed while referring to the input information in the past, the user does not need to display the operation screen of the past each time the user refers to the past input and can effectively perform the input operation on the operation screen.

### Modified Embodiment 4

FIG. 9 is a diagram exemplifying a functional configuration of a help display control program 500 in Modified Embodiment 4.

As exemplified in FIG. 9, the help display control program 500 has a functional configuration in which a help control unit 508 replaces the help control unit 108 of the help display control program 100 illustrated in FIG. 2, a help screen display unit 514 replaces the help screen display unit 114, and a count unit 516 is further added. Here, the help display control program 500 further reads and writes a count data base (count DB) 518.

A part or whole of the functional units of the help display control program 500 may be realized by hardware such as an ASIC.

Hereinafter, a description will be given of those units that are different from the units of the help display control program 100 illustrated in FIG. 2.

The help control unit 508 obtains help information based on a help ID notified from the help I/F unit 106.

In this example, the help control unit 508, first, obtains help acquisition information for acquiring help information from the help map DB 110 based on the help ID notified from the help I/F unit 106. The help control unit 508, then, obtains the help information from the help information DB 112 based on the help acquisition information that has been obtained from the help map DB 110.

Further, in this example, the help control unit 508 notifies the help screen display unit 514 of the help ID used for obtaining the help information so as to indicate which operation screen has been displayed.

In accordance with an operation screen displayed by the operation screen display unit 104, the help screen display unit 514 displays the help relating to this operation screen. During such a process, the help screen display unit 514 changes a display size of the help screen according to the number of displayed times counted by the count unit 516.

In this example, the help screen display unit 514 displays the help information received by the help control unit 508 on a help screen that is different from the operation screen displayed by the operation screen display unit 104.

Further, in this example, the help screen display unit 514 makes the count unit 516 count the number of displayed times of the operation screen based on the help ID notified from the help control unit 508. Then, the help screen display unit 514 refers to the count DB 518 and displays the help screen in a reduced size based on the number of displayed times of an operation screen which is identified by the help ID. During this process, for example, the help screen display unit 514 may largely change the reduction ratio of the help screen every time the number of displayed times of the operation screen becomes equal to or larger than a predetermined number.

The count unit 516 counts the number of displayed times of each operation screen or the number of displayed times of each help screen.

In this example, the count unit 516 counts the number of displayed times of each operation screen based on the help ID notified from the help control unit 508. Then, the count unit 516 stores the number of displayed times of each operation screen thus counted in the count DB 518 in association with the help ID.

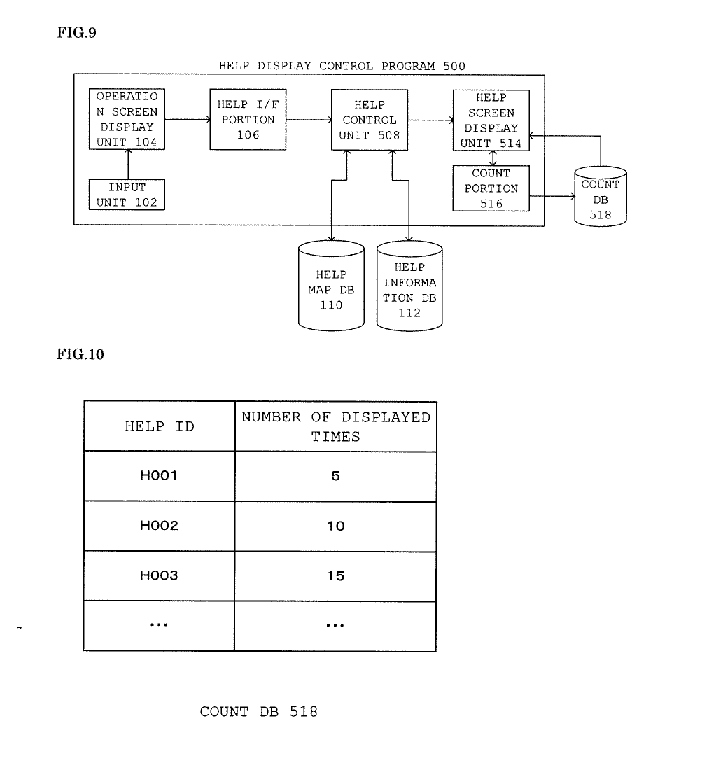

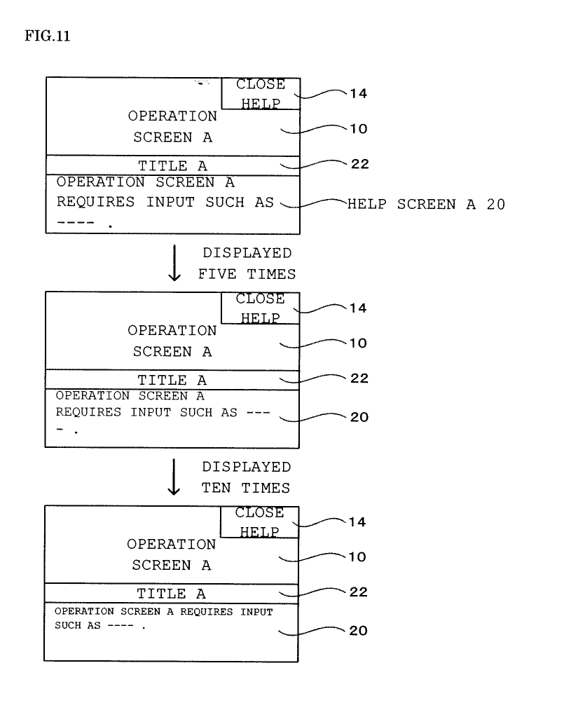

As exemplified in FIG. 10, the count DB 518 includes “Help ID” and “Number of Displayed Times” as data items.

The help ID is the same as the help ID of the help map DB 110 illustrated in FIG. 3.

The number of displayed times indicates the number instances in which each operation screen is displayed by the operation screen display unit 104.

By installing the help display control program 500 described above on a computer, the computer includes functions implemented by the help display control program 500 and operates as the help display controller or the image reading apparatus 1.

FIG. 11 is a descriptive view depicting changes of screens displayed by the image reading apparatus 1 in Modified Embodiment 4.

As exemplified in FIG. 11, the image reading apparatus 1 reduces and displays the help shown on the help screen 20 every time the operation screen A 10 has been displayed a predetermined number of times (five times in this example).

According to the configuration and operation as described above, every predetermined number of times or more the image reading apparatus 1 displays the operation screen to the user, the image reading apparatus 1 reduces the display of the help that corresponds to this operation screen. With this arrangement, the image reading apparatus 1 can display the help in a more easily viewable manner according to the level of proficiency of a user in manipulating the operation screens. As the level of proficiency of a user increases in manipulating the operation screens, the user needs the help less frequently. Accordingly, the image reading apparatus 1 may be arranged in such a way to automatically hide the help when the number of displayed times of the operation screen reaches a predetermined number or more.

### Other Modified Embodiment

The image reading device 1 according to the foregoing embodiment and modified embodiments may be replaced with an image printing apparatus. In such a case, the image printing apparatus includes a printing unit for printing image data instead of the image reading unit 7 of the image reading apparatus 1.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image reading apparatus comprising:
an image reading unit that reads image data optically from an information display medium;
an operation screen display unit that displays an operation screen to receive input from a user with respect to an image reading process performed by the image reading unit; and
a help screen display unit that displays, in accordance with a displayed operation screen displayed by the operation screen display unit, help guidance relating to the displayed operation screen in a manner that the help guidance and the displayed operation screen are visible at the same time.

2. The image reading apparatus according to claim 1, wherein, when an operation screen displayed by the operation screen display unit is changed to another operation screen, the help screen display unit changes display over to help guidance relating to said another operation screen.

3. The image reading apparatus according to claim 1, further comprising a count unit that counts a number of instances where each operation screen is displayed by the operation screen display unit or a number of instances where each help screen is displayed by the help screen display unit,
wherein the help screen display unit changes a display size of the help guidance to be displayed in accordance with the number of instances counted by the count unit.

4. An image reading apparatus comprising:
an image reading unit that reads image data optically from an information display medium;
an operation screen display unit that displays a series of operation screens associated with one another to receive input from a user with respect to an image reading process performed by the image reading unit; and
a reference screen display unit that displays, in accordance with a displayed operation screen displayed by the operation screen display unit, another operation screen associated with the displayed operation screen as a reference screen,
wherein the reference screen is displayed in a manner that the reference screen and the displayed operation screen are visible at the same time.

5. An image printing apparatus comprising:
a printing unit that prints image data;
an operation screen display unit that displays an operation screen to receive input from a user with respect to a printing process performed by the printing unit; and
a help screen display unit that displays, in accordance with a displayed operation screen displayed by the operation screen display unit, help guidance relating to the displayed operation screen in a manner that the help guidance and the displayed operation screen are visible at the same time.

6. A help display controller comprising:
an operation screen display unit that displays an operation screen to receive input from a user; and
a help screen display unit that displays, in accordance with a displayed operation screen displayed by the operation screen display unit, help guidance relating to the displayed operation screen in a manner that the help guidance and the displayed operation screen are visible at the same time.

7. A non-transitory computer-readable medium storing thereon a computer program used in a computer, the computer program causing the computer to perform:
an operation screen display function that displays an operation screen to receive input from a user; and
a help screen display function that displays, in accordance with a displayed operation screen displayed by the operation screen display function, help guidance relating to the displayed operation screen in a manner that the help guidance and the displayed operation screen are visible at the same time.

8. A help display control method comprising:
an operation screen displaying step to display an operation screen to receive input from a user; and
a help displaying step to display, in accordance with a displayed operation screen displayed in the operation screen displaying step, help guidance relating to the displayed operation screen in a manner that the help guidance and the displayed operation screen are visible at the same time.
